(19) United States
(12) Patent Application Publication
(10) Pub. No.: US 2009/0298468 A1
(43) Pub. Date: Dec. 3, 2009

(54) SYSTEM AND METHOD FOR DELETING DATA IN A COMMUNICATION DEVICE

(75) Inventor: CHIH-PU HSU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/337,637

(22) Filed: Dec. 18, 2008

(30) Foreign Application Priority Data
Jun. 2, 2008 (CN) 200810301928.8

(51) Int. Cl. H04W 12/08

(52) U.S. Cl. 455/411

(57) ABSTRACT

A method and system for deleting data in a communication device sets a secure command in a predetermined communication device, determines if the predetermined communication device has been lost and/or stolen, invokes the secure command to delete data in the predetermined communication device if the predetermined communication device has been lost and/or stolen.

### BACKGROUND

1. Field of the Invention

Embodiments of the present disclosure relate to data management systems and methods, and more particularly to a system and method for deleting data in a communication device.

2. Description of Related Art

Recently, multifunctional and large-volume communication devices have been developed. These communication devices have storage devices stored therein for storing information, such as an address book, mail, transmission/reception history, short messages, photographs, digital videos, and so on. With dependences on the communication devices increasing, a risk is growing correspondingly. In case that the communication devices are lost, the information that should not be leaked out might often leak out. Since such information contains personal information of users, the personal information may be confidential. Leakage of such personal information may result in many problems.

What is needed, therefore, is an improved system and method for deleting data in a communication device when the communication device is lost, so as to protect personal information.

### BRIEF DESCRIPTION OF THE DRAWINGS

FIG. 1 is a block diagram of one embodiment of a system for deleting data in a communication device.

FIG. 2 is a flowchart of one embodiment of a method for setting data in the communication device.

FIG. 3A and FIG. 3B are flowcharts of one embodiment of a method for deleting data in the communication device.

### DETAILED DESCRIPTION OF CERTAIN INVENTIVE EMBODIMENTS

All of the processes described below may be embodied in, and fully automated via, functional code modules executed by one or more general purpose computers or processors. The code modules may be stored in any type of computer-readable medium or other storage device device. Some or all of the methods may alternatively be embodied in specialized computer hardware or communication apparatus.

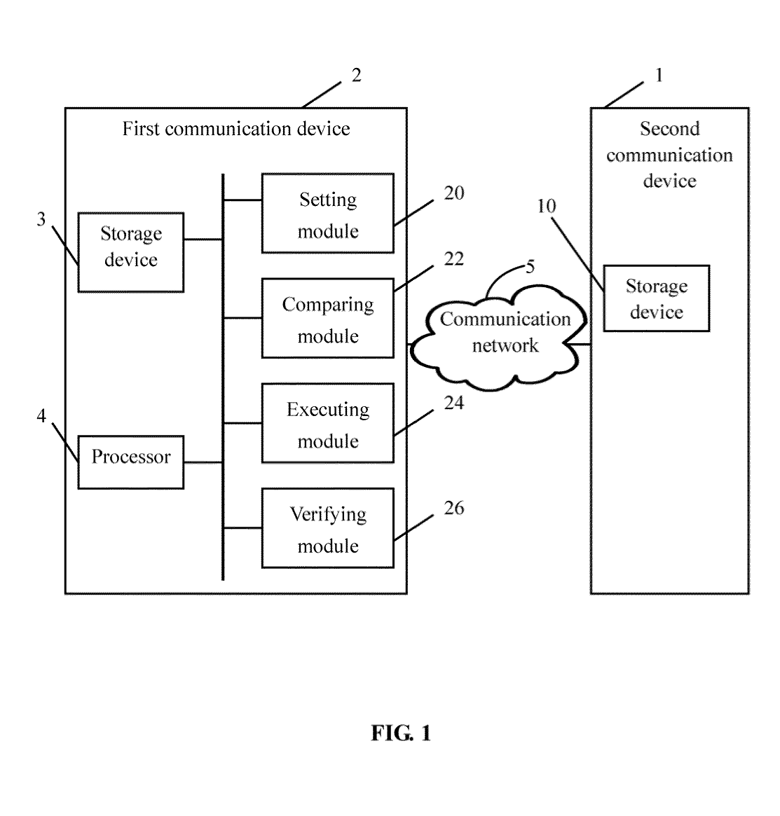

FIG. 1 is a block diagram of one embodiment of a system for deleting data in a communication device (hereinafter referred to as “the data deletion system”). To better detail the embodiment, the data deletion system may include two communication devices (e.g., a mobile phone), one of the two communication devices is initiated to delete data in a predetermined communication device, will be described as a second communication device 1, and the predetermined communication device will be described as a first communication device 2.

The first communication device 2 communicates with the second communication device 1 via a communication network 5. Depending on the embodiment, the communication network 5 may be the Global System for Mobile communication (GSM) network, the General Packet Radio Service (GPRS) network, or the Internet, for example.

The first communication device 2 includes a storage device 3 and at least one processor 4. The storage device 3 is used for storing various kinds of data, such as short messages, photographs, digital videos, etc. Depending on the embodiment, the storage device 3 may include a memory of the first communication device 2 or an external storing card, such as a memory stick, a Subscriber Identity Model (SIM) card, for example. Depending on the embodiment, the first communication device 2 may be a mobile phone, or a personal digital assistant.

The second communication device 1 comprises a storage device 10 and is used for storing various data, such as an operating system, applications, and various data related thereof. The second communication device 1 may be used to send a short message to the first communication device 2 over the communication network 5 to delete data off the first communication device 2 as will be explained in greater detail below. Depending on the embodiment, the second communication device 1 may be a mobile phone, a personal digital assistant, or a computing device. The short message may be sent over the Short Message Service (SMS) communication protocol or via the Internet, in one exemplary embodiment.

In one embodiment, the first communication device 2 may include a setting module 20, a comparing module 22, and an executing module 24. The modules 20, 22, 24 and 26 may be used to perform one or more operations for the first communication device 2. In another embodiment, the first communication device 2 may include one or more specialized or general purpose processors, such as the at least one processor 4 for executing at least one operation for the modules 20, 22, 24 and 26.

The setting module 20 is configured for setting a user name and a password. The user name and the corresponding password are set for verifying an identity of a user of the first communication device 2. The setting module 20 is also configured for setting a data deletion function, and setting a hotkey for activating the data deletion function provided by the data deletion system.

The data deletion function is configured for deleting data stored in the storage device 3 of the first communication device 2 when the first communication device 2 is lost, or when an original SIM card of the first communication device 2 has been replaced. In the embodiment of the present disclosure, the data deletion function may be hidden so as to avoid being deleted or discovered by others. In order to invoke the data deletion function, the user of the first communication device 2 may invoke a hotkey, such as “*@56@*,” for example.

The setting module 20 is further configured for setting a secure command for deleting the data stored in the storage device 3 of the first communication device 2, and setting an identification code for identifying the secure command. The secure command may include the set user name, the set password, and/or the identification code.

The secure command may be sent or received through a short message sent from the second communication device 1. In the embodiment of the present disclosure, the secure command may be preset as a key for activating the data deletion function to delete the data stored in the storage device 3 of the first communication device 2.

The comparing module 22 is configured for comparing textual data of a received short message with the secure command, and determining if the textual data is substantially the same as the secure command. If the textual data is substantially the same as the secure command, the comparing module 22 determines that the received short message is the secure command; otherwise, if the textual data is different from the secure command, the comparing module prompts that the first communication device 2 has received a new short message.

The executing module 24 is configured for invoking the secure command to delete the data stored in the storage device 3 of the first communication device 2 if the received short message is determined to be the secure command. The secure command may be sent to the first communication device 2 from the second communication device 1 when the first communication device 2 lost or stolen, for example. Then the secure command preset in the first communication device 2 is invoked to delete the data stored in the storage device 3 of the first communication device 2, so as to avoid divulging secret, private, or confidential information of the first communication device 2.

If the original SIM card of the first communication device 2 has been replaced, the first communication device 2 may not receive the secure command. For the purpose of securing the data in the first communication device 2, the first communication device 2 may further include a verifying module 26.

The verifying module 26 is configured for verifying if the original SIM card in the first communication device 2 has been replaced. It may be understood that every SIM card has an unique International Mobile Subscriber Identity (IMSI) code, which is read by each communication device when each communication device is powered on. The verifying module 26 records an IMSI code of a SIM card of the first communication device 2 each time the first communication device 2 is powered on, and determines if the original SIM card of the first communication device 2 has been replaced by determining if a currently recorded IMSI code is the same as a last recorded IMSI code. If the currently recorded IMSI code is the same as the last recorded IMSI code, the verifying module 26 determines that the original SIM card of the first communication device 2 has not been replaced; otherwise, if the currently recorded IMSI code is different from the last recorded IMSI code, the verifying module 26 determines that the original SIM card of the first communication device 2 has been replaced.

The verifying module 26 is further configured for prompting the user to input a user name and a corresponding password if the original SIM card has been replaced, and determining if the input user name and the input password are correct according to the set user name and the set password. If the input user name and the input password are correct, an operation system of the first communication device 2 is entered.

The setting module 20 is further configured for presetting a maximum login attempt for limiting login attempt failure of an inaccurate user name or an inaccurate password. The verifying module 26 is further configured for counting the login attempt failure of the inaccurate user name or the inaccurate password, and determining if the login attempt failure is equal to the preset maximum login attempt.

If the login attempt failure is equal to the preset maximum login attempt, the executing module 24 is further configured for invoking the secure command to delete the data stored in the first communication device 2. If the login attempt failure is less than the preset maximum login attempt, the verifying module 26 prompts the user to input a user name and a corresponding password until the login attempt failure is equal to the preset maximum login attempt or the input user name and the input password are verified to be correct.

In another embodiment, the verifying module 26 may be configured for determining if the first communication device 2 is connected to any electronic device (e.g., the desktop computer, the notebook, the PDA, etc.), and prompting the user to input a user name and a corresponding password if the first communication device 2 is connected to any other kind of electronic device (e.g., a personal computer, a notebook, a personal digital assistant, etc.).

The verifying module 26 determines if the input user name and the input password are correct according to the set user name and the set password. If the input user name and the input password are correct, the executing module 24 maintains a connection to the electronic device. Otherwise, if the input user name and the input password are incorrect or the login attempt failure of the inaccurate user name or the inaccurate password is equal to the preset maximum login attempt, the executing module 24 disconnects the connection between the first communication device 2 and the electronic device, and invokes the secure command to delete the data stored in the first communication device 2. Verifying the connection between the first communication device 2 and any kind of electronic device avoids secret, private, confidential data in the first communication device 2 from being transmitted to the electronic device unbeknown.

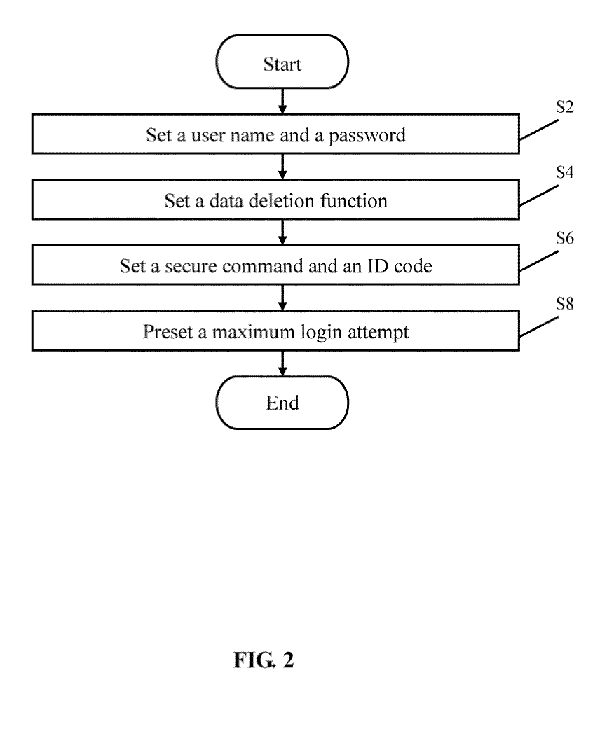

FIG. 2 is a flowchart of one embodiment of a method for setting data in the first communication device 2. Depending on the embodiment, additional blocks may be added, others removed, and the ordering of the blocks may be replaced.

In block S2, the setting module 20 sets a user name and a password. The user name and the password are configured for verifying an identity of a user of the first communication device 2 when the user accesses the first communication device 2.

In block S4, the setting module 20 sets a data deletion function, and sets a hotkey for activating the data deletion function. Generally, the data deletion function is invoked by default when the first communication device 2 is powered on.

In block S6, the setting module 20 sets a secure command for deleting data stored in the first communication device 2, and sets an identification code for identifying the secure command. The secure command may include the set user name, the set password, and/or the identification code, for example.

In block S8, the setting module 20 presets a maximum login attempt.

If the data set in the first communication device 2 needs to be modified, added, or deleted, the verifying module 26 prompts the user to input a user name and a corresponding password to verify the identity of the user.

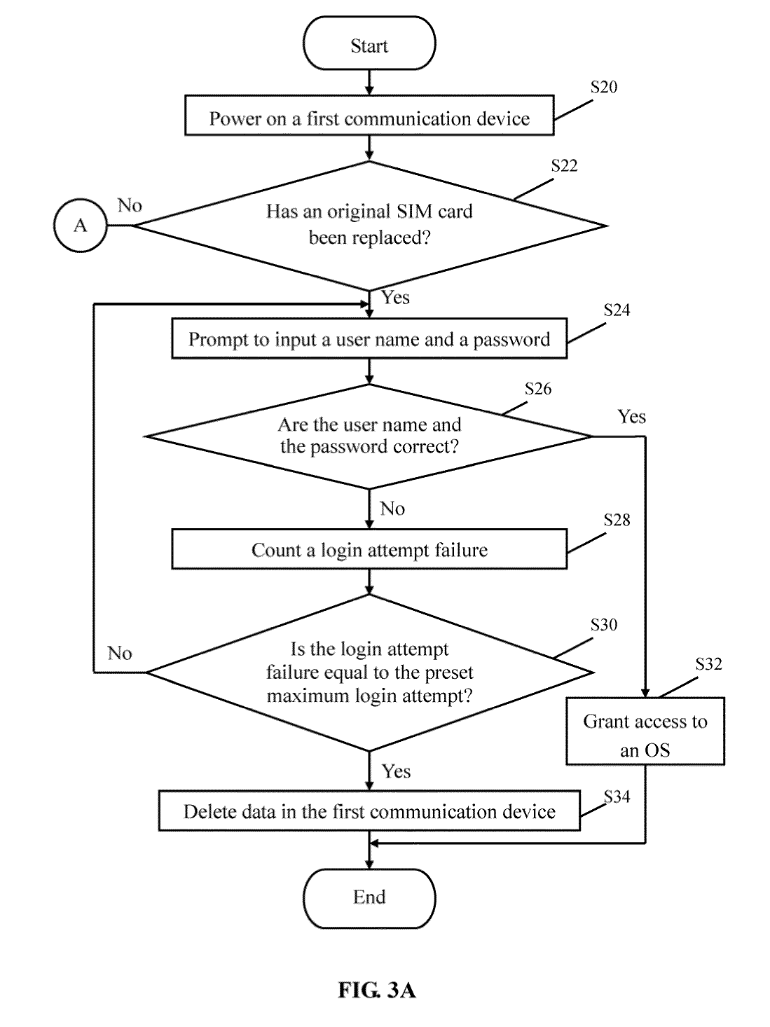

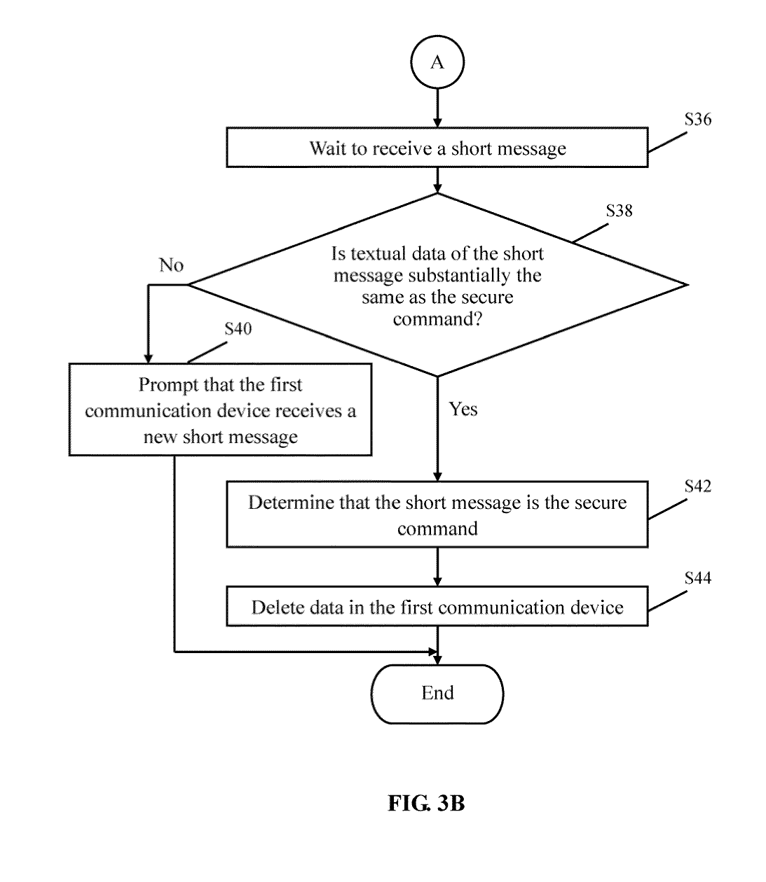

FIG. 3A and FIG. 3B are flowcharts of one embodiment of a method for deleting data in the first communication device 2. Depending on the embodiment, additional blocks may be added, others removed, and the ordering of the blocks may be replaced.

In block S20, the first communication device 2 is powered on, and the data deletion function is invoked correspondingly.

In block S22, the verifying module 26 verifies if an original SIM card in the first communication device 2 has been replaced by comparing a currently recorded IMSI code and a last recorded IMSI code. If the currently recorded IMSI code is the same as the last recorded IMSI code, the original SIM card is determined to be replaced; otherwise, the original SIM card is determined to be not replaced.

If the SIM card has been replaced, in block S24, the verifying module 26 prompts a user to input a user name and a corresponding password. In block S26, the verifying module 26 determines if the input user name and the input password are correct according to the set user name and the set password. If the input user name and the input password are correct, in block S32, the first communication device 2 grants access to an operation system of the first communication device 2.

If the input user name and the input password are incorrect, in block S28, the verifying module 26 counts a login attempt failure. In block S30, the verifying module 26 determines if the login attempt failure is equal to the preset maximum login attempt.

If the login attempt failure is equal to the preset maximum login attempt, in block S34, the executing module 24 invokes the secure command to delete the data stored in the first communication device 2. If the login attempt failure is less than the preset maximum login attempt, the procedure returns to block S24.

If the SIM card is determined to be not replaced, in block S36, the first communication device 2 waits to receive a short message from the second communication device 1.

In block S38, the comparing module 22 compares textual data of the received short message with the secure command, and determines if the textual data is substantially the same as the secure command. If the textual data is different from the secure command, in block S40, the comparing module 22 prompts that the first communication device 2 has received a new short message.

If the textual data is substantially the same as the secure command, in block S42, the comparing module 22 determines that the received short message is the secure command. In block S44, the executing module 24 invokes the secure command to delete the data stored in the first communication device 2.

In another embodiment, the verifying module 26 may determine if the first communication device 2 is connected to any kind of electronic device (e.g., the desktop computer, the notebook, the PDA, etc.) during the first communication device 2 is powered on. If the first communication device 2 is connected to any kind of electronic device, the verifying module 26 prompts the user to input a user name and a corresponding password, and determines if the input user name and the input password are correct according to the set user name and the set password.

If the input user name and the input password are correct, a connection between the first communication device 2 and the electronic device is maintained. Otherwise, if the input user name and the input password are incorrect or the login attempt failure of the inaccurate user name or the inaccurate password is equal to the preset maximum login attempt, the executing module 24 disconnects the connection between the first communication device 2 and the electronic device, and invokes the secure command to delete the data stored in the first communication device 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for deleting data in a communication device, the computing system comprising:
a setting module configured for setting a user name and a password, and setting a secure command for deleting the data stored in the communication device;
a comparing module configured for comparing textual data of a received short message with the secure command, and determining if the textual data of the received short message is substantially the same as the secure command;
an executing module configured for invoking the secure command to delete the data stored in the communication device if the textual data of the received short message is substantially the same as the secure command; and
at least one processor that executes the setting module, the comparing module, and the executing module.

2. The system according to claim 1, further comprising a verifying module configured for verifying if an original Subscriber Identity Model (SIM) card in the communication device has been replaced, prompting a user to input a user name and a corresponding password if the original SIM card has been replaced, and determining if the input user name and the input password are correct according to the set user name and the set password.

3. The system according to claim 2, wherein the executing module is further configured for invoking the secure command to delete the data stored in the communication device if the input user name and the input password are incorrect.

4. The system according to claim 1, wherein the comparing module is further configured for prompting a user that the communication device has received a new short message if the textual data of the received short message is different from the secure command.

5. The system according to claim 1, wherein the setting module is further configured for setting an identification code for identifying the secure command.

6. The system according to claim 5, wherein the secure command comprises the set user name, the set password, and/or the identification code.

7. The system according to claim 1, wherein the received short message is sent and received over a communication network, which is the Internet or a wireless cellular network.

8. A computer-implemented method for deleting data in a communication device, the method comprising:
setting a user name and a password, and setting a secure command for deleting the data stored in the communication device;
receiving a short message by the communication device;
comparing textual data of the received short message with the secure command, and determining if the textual data of the received short message is substantially the same as the secure command; and
invoking the secure command to delete the data stored in the communication device if the textual data of the received short message is substantially the same as the secure command.

9. The method according to claim 8, further comprising:
verifying if an original Subscriber Identity Model (SIM) card in the communication device has been replaced before the step of receiving a short message by the communication device; and
executing the step of receiving a short message by the communication device, if the original SIM card has not been replaced; or
executing an identity authentication procedure if the original SIM card has been replaced.

10. The method according to claim 9, wherein the identity authentication procedure comprises:
prompting a user to input a user name and a corresponding password;
determining if the input user name and the input password are correct according to the set user name and the set password; and
entering an operating system of the communication device if the input user name and the input password are correct, and executing the step of receiving a short message by the communication device; or
invoking the secure command to delete the data stored in the communication device, if the input user name and the input password are incorrect.

11. The method according to claim 8, further comprising:
prompting that the communication device has received a new short message if the textual data of the received short message is different from the secure command.

12. The method according to claim 8, wherein the step of setting a user name and a password, and setting a secure command for deleting the data stored in the communication device comprises:
setting an identification code for identifying the secure command.

13. The method according to claim 12, wherein the secure command comprises the set user name, the set password, and/or the identification code.

14. A storage medium having stored thereon instructions that, when executed by a processor, causing the processor to perform a method for deleting data in a communication device, the method comprising:
setting a user name and a password, and setting a secure command for deleting the data stored in the communication device;
receiving a short message by the communication device;
comparing textual data of the received short message with the secure command, and determining if the textual data of the received short message is substantially the same as the secure command; and
invoking the secure command to delete the data stored in the communication device if the textual data of the received short message is substantially the same as the secure command.

15. The medium according to claim 14, wherein the method further comprises:
verifying if an original Subscriber Identity Model (SIM) card in the communication device has been replaced before the step of receiving a short message by the communication device; and
executing the step of receiving a short message by the communication device, if the original SIM card has not been replaced; or
executing an identity authentication procedure if the original SIM card has been replaced.

16. The medium according to claim 14, wherein the identity authentication procedure comprises:
prompting a user to input a user name and a corresponding password;
determining if the input user name and the input password are correct according to the set user name and the set password; and
entering an operating system of the communication device if the input user name and the input password are correct, and executing the step of receiving a short message by the communication device; or
invoking the secure command to delete the data stored in the communication device, if the input user name and the input password are incorrect.

17. The medium according to claim 14, wherein the method further comprises:
prompting that the communication device has received a new short message if the textual data of the received short message is different from the secure command.

18. The medium according to claim 14, wherein the step of setting a user name and a password, and setting a secure command for deleting the data stored in the communication device comprises:
setting an identification code for identifying the secure command.

19. The medium according to claim 18, wherein the secure command comprises the set user name, the set password, and/or the identification code.
